(19) United States
(12) Patent Application Publication
(10) Pub. No.: US 2020/0130709 A1
(43) Pub. Date: Apr. 30, 2020

(54) METHOD AND DEVICE FOR DETERMINING A CONFIGURATION FOR AN AUTONOMOUS VEHICLE

(71) Applicants: Intel Corporation, Santa Clara, CA (US); Mobileye Vision Technologies Ltd., Jerusalem (IL)

(72) Inventors: Alena RODIONOVA, Philadelphia, PA (US); Ignacio ALVAREZ, Portland, OR (US)

(21) Appl. No.: 16/726,276

(22) Filed: Dec. 24, 2019

(51) Int. Cl. B60W 60/00; G05B 13/04; G05D 1/00; B60W 50/00

(52) U.S. Cl. CPC B60W 60/0015; G05B 13/042; B60W 2555/60; B60W 50/0098; B60W 2050/0088; G05D 1/0088

(57) ABSTRACT

According to various embodiments, a method for determining a configuration for an autonomous vehicle is described comprising, for each configuration parameter setting of a plurality of configuration parameter settings and each driving scenario of a plurality of driving scenarios, simulating a behavior of an autonomous vehicle configured in accordance with the configuration parameter setting in the driving scenario and determining a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting and selecting one or more configurations for the autonomous vehicle based on the determined measures of a safety that meet a threshold degree of safety.

### TECHNICAL FIELD

The present disclosure relates to methods and devices for determining a configuration for an autonomous vehicle.

### BACKGROUND

Safety is a major concern in autonomous driving. While self-driving vehicles can be expected to reduce the number of accidents since software is less error-prone than humans, safety issues must be resolved to the full satisfaction of the public to gain widespread acceptance of autonomous vehicles.

The safety of an autonomous vehicle depends on the configuration of the vehicle (e.g. how good are the breaks etc.) including in particular values of configuration parameters of the autonomous driving controller (e.g. how fast should the autonomous vehicle try to reach the target).

Accordingly, approaches for determining values of configuration parameters of an autonomous vehicle that allow efficient driving while ensuring high safety are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an autonomous vehicle.

FIG. 2 shows a flow diagram illustrating a method to generate a safety profile of configuration parameters according to an embodiment.

FIG. 3 shows examples for safety profiles obtained by bivariate analysis. FIG. 4 illustrates an emergency break assist scenario.

FIGS. 5 and 6 show example renderings of an emergency break assist scenario in a simulation.

FIG. 7 shows a rendering of an intersection scenario.

FIG. 8 shows a flow diagram illustrating a method for determining a configuration for an autonomous vehicle according to an embodiment.

FIG. 9 shows a vehicle configuration arrangement for determining a configuration for an autonomous vehicle.

### DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

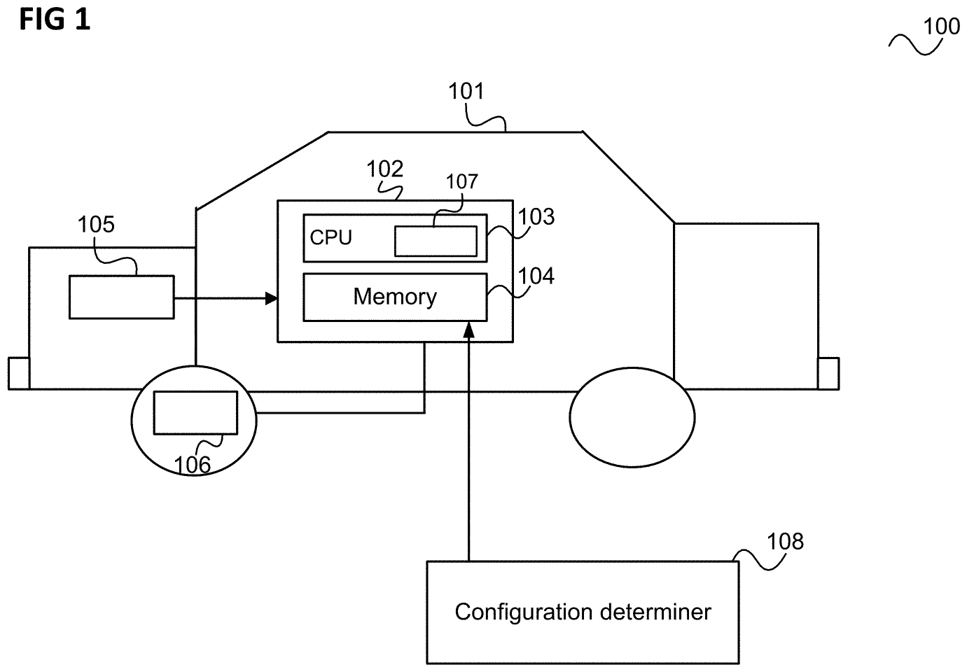

FIG. 1 shows an autonomous vehicle 101.

The vehicle 101, for example a car, van or motorcycle is provided with a vehicle controller 102. The vehicle controller 102 includes data processing components, e.g. a processor (e.g. a CPU (central processing unit)) 103 and a memory 104 for storing control software (also denoted as “AV code”) according to which the vehicle controller 102 operates and data processed by the processor 103.

For example, the stored control software includes instructions that, when executed by the processor 103, make the processor carry out a control process 107 for the vehicle 100. This may for example include the implementation of a machine learning model such as a neural network, for example for object detection and classification. The control method may for example detect and classify objects (such as obstacles) and control the vehicle 100 accordingly.

For object detection and classification, the data stored in memory 104 can include input sensor data from one or more cameras 105. The one or more cameras 105 may for example output greyscale or color pictures of the vehicle's environment. The vehicle controller 102 may determine the presence of objects, e.g. fixed objects, such as traffic signs or road markings, and/or moving objects, such as pedestrians, animals and other vehicles, based on the input sensor data. The vehicle controller 102 may then control the vehicle 101 in accordance with the results of the object determination. For example, the vehicle controller 102 may control an actuator 106 to control the vehicle's speed, e.g. to actuate the brakes of the vehicle.

The vehicle 101 operates according to certain configuration parameters, for example include the maximum acceleration and the maximum deceleration (when braking). In particular, configuration parameters may include various control parameters which the vehicle controller 102 may take into account when controlling the vehicle (e.g. the maximum acceleration it uses, which may be below the maximum acceleration the vehicle is capable of). Values for the configuration parameters (such as control parameters) are for example provided by a configuration parameter source or configuration determiner 108 which may provide the configuration parameter values to the vehicle 100 to be stored in memory 104 where they may be accessed by the CPU 103 performing the control process 107. The storage of the configuration parameter values in the memory 104 may happen upon manufacturing of the vehicle or they may also be stored or updated later (after deployment of the vehicle). The configuration parameters may also include parameters that are more static, i.e. cannot be dynamically updated or changed. For example, the vehicle controller may be configured to have a certain reaction time (e.g. between getting camera pictures of a breaking vehicle in front of the vehicle 101 and starting to break) which may not be simply changed by a software update (but may for example require a hardware upgrade). Further, certain limits of control parameters (like maximum braking deceleration) may be given by configuration parameters that cannot be easily changed by update (but for example require different braking parts).

Depending on the values of the configuration parameters that are used, a certain safety profile of autonomous driving is achieved. Safety is the number one challenge for commercial (mass) deployment of automated Vehicle technology. Industry players have been pushing their Autonomous Vehicle (AV) safety vision with frameworks in the form of “Robot Safety Laws”. For example, a formal, mathematical model has been introduced to help ensure that an autonomous vehicle is operated in a safe manner. Another model is Safety Force Field (SFF) which describes safety at the obstacle avoidance level and defines safety requirements. Such models do not guarantee absolute safety, but rather guarantee that the self-driving car will never initiate a dangerous situation.

With multiple possible solutions being proposed the automated driving industry faces yet another issue, namely standardization of safety assurances. Regulatory bodies usually ask for deterministic AV Safety frameworks whose behavior is guaranteed upon selection of configuration parameter values. These configuration parameter values might be different depending on local regulations or even driving situations.

Given that the proposed models are parametric, understanding the configuration parameter impact on the overall safety is crucial before making decision since incorrect assumptions about environmental variables or choices for internal configuration parameter values of the model can lead to different performance in collision prevention and can critically affect the operating safety envelope of an autonomous vehicle. Without a consensus on parameter models industry cannot move forward

According to various embodiments, a method and system to automatically determine the boundaries of parametric safety models for automated vehicles are provided. Such a system may be used as configuration determination system for determining configuration parameter values for an autonomous vehicle (e.g. corresponding to the configuration determiner 108).

Further, according to various embodiments, a system to develop safety benchmarks that help understand the impact of different configuration parameters (which may correspond to model parameters of the safety model used for evaluating safety) may be provided. Various embodiments allow automatical discovery and analysis of dangerous safety behaviors of an autonomous vehicle (depending on configuration parameters) and provision of data to determine the appropriate boundary of AV safety constraints (e.g. boundaries of configuration parameter settings to ensure that the vehicle's behavior stays in a region of safe driving).

Various embodiments perform analysis based on the internal parameters of the safety model while external (environmental) parameters are also available for exploration of impact. This means that external variations (environmental) having an impact to system safety as well as internal variations (configuration) having an impact to system safety may be considered. The overall coverages are for example set to satisfy benchmark requirements for AV safety verification. According to various embodiments, analysis is carried out automatically in a multidimensional parametric space (i.e. a space of configuration parameter settings, e.g. settings including values for multiple configuration parameters). Further, visualizations of the robustness envelop, in reference to one or more parameter variables may be provided.

According to various embodiments a configuration parameter determination system (e.g. corresponding to configuration parameter determiner 108) uses a simulation for evaluating a safety level (e.g. a robustness). This is less expensive and time-consuming than collecting data for autonomous vehicles by running real-world experiments and is therefore better scalable.

According to various embodiments, a formal framework of robustness (robustness-guided testing methodology) is applied to establish the safety boundaries for autonomous vehicles enabling quantitative analysis of the degree to which safety specifications are satisfied across a range of scenarios and configuration (e.g. operation) parameters.

For example, according to various embodiments, robustness (i.e. robustness-guided testing) is applied to an executable environment representing automated vehicle's safety specifications and a virtual world through which traffic scenario orchestration is carried out. A result of various embodiments is the automatic determination of safety boundaries for autonomous vehicles, in particular a qualitative and quantitative analysis of the degree to which safety specifications are satisfied across a range of scenarios and configuration parameters.

In the following, embodiments are described in detail.

According to various embodiments, Automated Vehicle (AV) safety is defined as a continuous spectrum: it is defined to allow ranking of vehicle performances by their relative safety and comparing an autonomous vehicle performance across different scenarios. Such a continuous safety measure is for example provided by the robustness function of a Signal Temporal Logic (STL) safety specification. STL is a formalism that allows to define complex spatio-temporal requirements in a formal logic. STL removes ambiguities that are generally inherent in requirements expressed in natural language. Further, it supports two semantics: qualitative and quantitative. Qualitative semantics returns a Boolean value that the specification is either satisfied or violated by a given trajectory. Quantitative semantics returns a robustness degree, a continuous measure of “how much” the specification is satisfied. More precisely, given an AV safety requirement expressed as an STL formula ϕ, and system execution x̅, the robustness value ρ_{ϕ}(x̅) is a real number that measures two things about trajectory x̅:
its sign defines if the specification was satisfied (ρ_{ϕ}(x̅)>0) or violated (ρ_{ϕ}(x̅)<0), and
its magnitude (|ρ_{ϕ}(x̅)|) defines the bound on the perturbation that an execution x̅ can tolerate without changing its true value. Therefore, robustness is a continuous measure of safety of the autonomous vehicle relative to the desired properties: ρ_{ϕ}(x̅₁̅)>ρ_{ϕ}(x̅₂̅)>0 a means that both executions x̅₁̅ and x̅₂̅ are safe, but execution x̅₁̅ is more robustly safe than x̅₂̅.

According to various embodiments, robustness-guided testing is carried out which includes searching for the set of executions with low robustness. Assuming a deterministic simulator (which can be seen to carry out a function f:X₀→X mapping initial conditions to executions), it is equivalent to search for initial conditions x₀ (i.e. choices of values of configuration parameters, also referred to Safety Driving Model parameters) that lead to low robustness executions. It can be defined as the following optimization problem:

$${min}_{{x}_{0} ∈ {X}_{0}} {r}_{f} ( x )$$

$$subject to \text{:} x = f ( {x}_{0} )$$

Alternatively, e.g. to find the bounds between safe and unsafe configuration parameter choices, the absolute value of r_{f}(x) may be minimized:

$${min}_{{x}_{0} ∈ {X}_{0}} \vert {r}_{f} ( x ) \vert$$

$$subject to \text{:} x = f ( {x}_{0} )$$

The simulator and the AV software control stack (e.g. corresponding to controller 102) can be treated as black boxes. In such way the approach (e.g. used in a configuration parameter determination system) becomes flexible to future modifications, extensions and allows to plug-in any third-party AV code, including simple autopilot agents with a PID or an Safety Driving Model-compliant controller. The present approach incorporates the features to change the parametric values used in the simulation, thus modifying the AV safety responses.

According to various embodiments, it is not required to have the formal models of AV Safety (e.g. by using Signal Temporal Logic to define Safety Driving Model formulas), nor is a functional representation of the underlying system required (e.g. a representation of a mapping of configuration parameter values to robustness degrees). To allow a search of the parametric value space in that case, a gradient-free optimization heuristic is used.

For this, various zero-order optimization techniques may be used. One of such methodologies is uniform random search (URS). Given a current sample, the next sample is generated at uniform-random in the search-space. The algorithm iteratively updates a current sample with a generated one if the objective function has improved its value. Another possible methodology is low-discrepancy search (LDS). Such sampling technique in contrast with URS covers the search space quickly and evenly. Two main low-discrepancy sequences that can be used to generate new samples are Lattice sequence and Halton sequence.

A further possibility for a search methodology is simulated annealing (SA), a stochastic optimization algorithm for approximating the global optimum of a given function. Simulated annealing guarantees asymptotic convergence to a global minimum under some conditions on the problem definition.

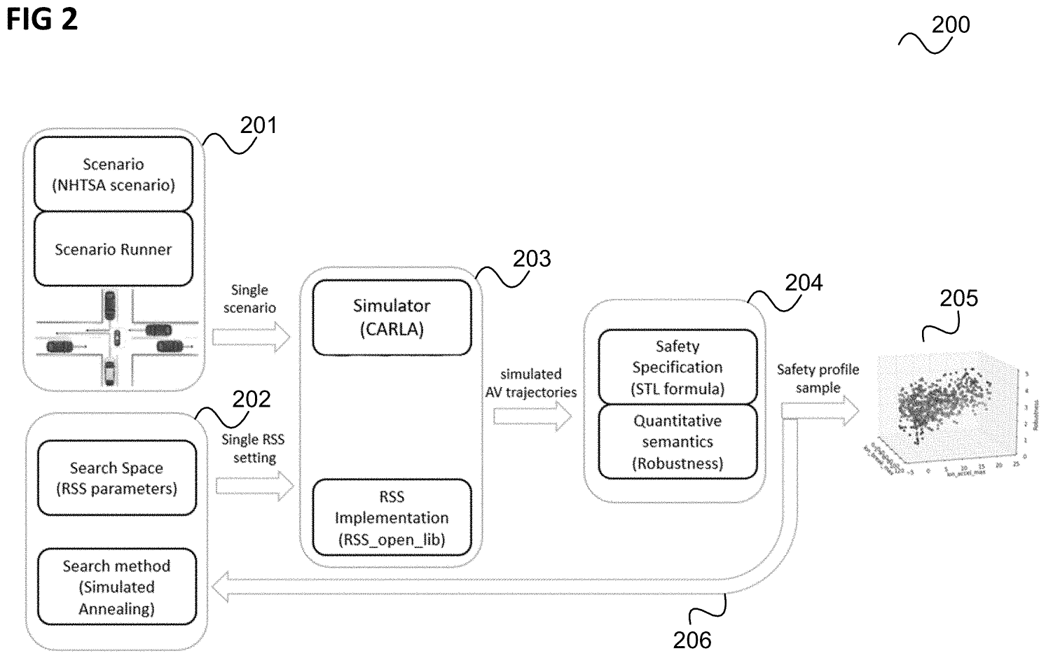

FIG. 2 shows a flow diagram 200 illustrating a method to generate a safety profile of configuration parameters according to an embodiment.

In 201, one or multiple traffic scenarios that represent a range of realistic driving conditions constituting a scenario benchmark are defined and implemented (e.g. using the traffic scenario definition and execution engine “Scenario Runner”). The scenario definition can be specified in a proprietary or standardized format (e.g. OpenScenario) but includes the road topology, the number of road actors with their initial and final positions of the autonomous vehicle, target speeds, acceleration/deceleration profiles and other parameters of interest (e.g. maximum runtime, weather conditions, etc.).

In 202, the configuration parameter search space (also referred to as Safety Driving Model parameter search space) is defined. The configuration parameter search space may be multi-dimensional (one dimension for each configuration parameter) and a combination (i.e. vector) of configuration parameter values (including a value for each configuration parameter) is referred to as configuration parameter setting.

Further, a gradient-free optimization methodology (for finding a particular Safety Driving Model parameters setting) is chosen. This may for example be simulated annealing but other methods can be applied as well.

In 203, a simulation of one of the chosen (i.e. defined) scenarios of 201 is carried out using a predetermined simulator (e.g. a version of a driving simulator (CARLA) with an integrated Safety Driving Model Library) and using a single Safety Driving Model parameter setting of the Safety Driving Model search space (that may be used by the autonomous vehicle controller that respects Safety Driving Model rules). Thus, each chosen scenario (i.e. each scenario defined in 201 and used for simulation in 203) constitutes a safety scenario benchmark.

In 204, for a simulated autonomous vehicle trajectory (obtained by the simulation of 203) and a predefined STL specification a robustness value is obtained using quantitative STL semantics.

The Safety Driving Model parameter setting (for which the simulation was made) together with the corresponding robustness value defines a single sample on a safety profile. In 206, this sample is fed to the optimization technique chosen in 202 which outputs an Safety Driving Model parameter setting for a subsequent simulation.

In this way, an optimization is carried out in a loop (simulation in 203 for an Safety Driving Model parameter setting, calculation of robustness value in 204 and choice of a subsequent Safety Driving Model parameter setting by the optimization technique of 202) until a termination criterion is fulfilled. The termination criterion can be determined by a user-defined setup such as sampling size or time (e.g. according to the computational capabilities of the deployed system used to carry out the method of FIG. 2).

According to various embodiments, the method described with reference to FIG. 2 allows to plug-in a third-party AV code (controller), so the autonomous vehicle can drive in the simulated world and collect all relevant data from an execution, like distance to obstacles and time-to-collision. That means that the simulator of 203 may be supplied with a certain autonomous vehicle control scheme which the simulator uses as basis of the simulation. Furthermore, the method according to various embodiments supports the plugging of any safety specification written in Signal Temporal Logic (STL) formal language and supports the plug-in of general-purpose optimization algorithms that can then be used to search for dangerous driving situations.

The method of FIG. 2 is deterministic, meaning it supports replay of particular scenarios in order to visualize, analyze and debug the execution. If a combination of Safety Driving Model parameter values (i.e. an Safety Driving Model parameter setting) leads to an unsafe situation (e.g. a crash) the simulation can be rendered for review by a human user. This provides not only the robustness profiles visualization but a method to generate video sequences for general human review or analysis.

According to various embodiments, regarding safety profiles and methodology output, bivariate analysis (the values of two Safety Driving Model parameters are varied by the optimization algorithm) and multivariate analysis (the values of all Safety Driving Model parameters are varied) can be performed. Results of the bivariate analysis can be visualized in three dimensions. By depicting the particular Safety Driving Model setting on the XoY plane together with corresponding robustness value on the Z axis one can obtain a 3D representation of the safety profile.

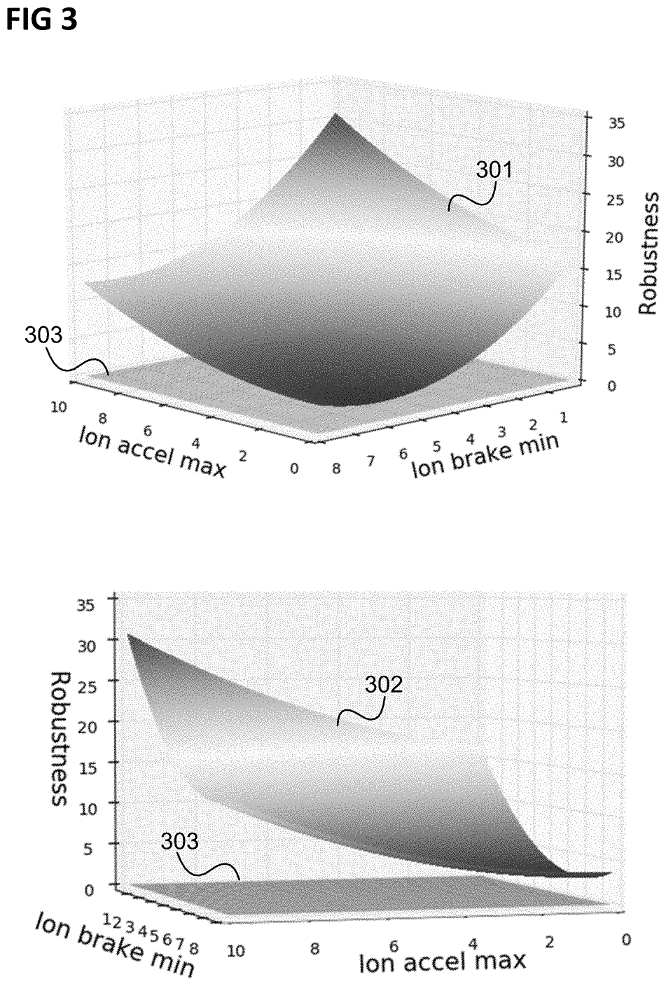

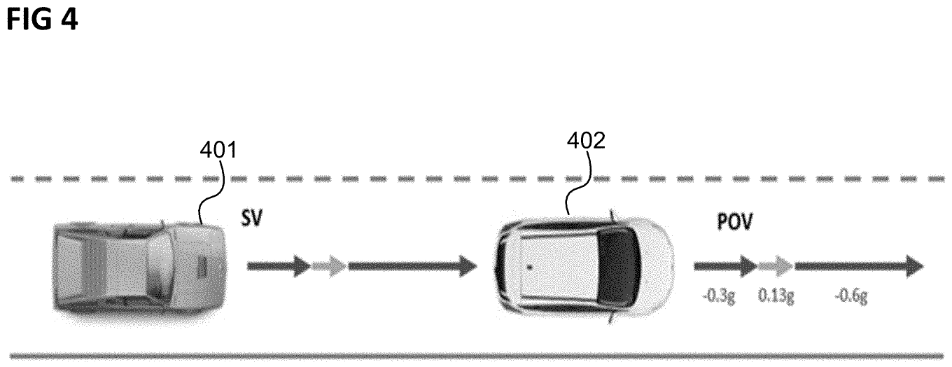

FIG. 3 shows examples for safety profiles obtained by bivariate analysis.

In this example, the two Safety Driving Model parameters that were the subject of change were “minimum longitudinal braking” and “maximum longitudinal acceleration”. Results of the multivariate analysis are harder to visualize. However multi-dimensional data visualization techniques can be applied for this purpose if it is necessary.

Both multivariate and bivariate analysis outputs represent robustness. In FIG. 3 the surfaces 301, 302 represents robustness (for respective combinations of the values of the two Safety Driving Model parameters). The lower a surface 301, 302 is the closer the performance of the vehicle for the respective parameter value combination is to a dangerous situation. The horizontal plane of robustness zero 303, 304 represents the limit between success and failure (e.g. accident).

Regarding the determination of scenarios (i.e. the definition of scenarios in 201 used for the simulation), guidelines such as provided by Government or regulatory bodies (e.g. the US Department of Transportation), in particular the National Highway Traffic Safety Administration (NHTSA) may be followed. The NHTSA released a set of 37 scenarios that upon analysis are deemed to cause over 90% of the recorded accidents. Some or all of those scenarios may be implemented in 201 as a basis for the simulation. Some of those scenarios stress a particular subset of parameters from a safety model while other scenarios might stress the complete formulation. For example, an emergency break assist scenario as shown in FIG. 4 is only relevant for the Safety Driving Model longitudinal safety formula which contains a set of six Safety Driving Model parameters.

FIG. 4 illustrates an emergency break assist scenario.

An ego-vehicle (i.e. subject vehicle controlled by the autonomous vehicle control scheme plugged into the simulation) 401 follows a leading vehicle 402 which performs a scripted set of driving maneuvers.

The minimal safe longitudinal distance between the two vehicles 401, 402 is given by

$${d}_{m i n} = {[ {v}_{r} ρ + \frac{1}{2} {a}_{ma x , acc} {ρ}^{2} + \frac{{( {v}_{r} + {a}_{ma x , acc} ρ )}^{2}}{2 {a}_{m i n , br }} - \frac{{v}_{f}^{2}}{2 {a}_{ma x , br}} ]}_{+} \qquad ( 1 )$$

where [x]₊:=max {x, 0}
and where
vᵣ is the velocity of the subject vehicle 401 when the event occurs (i.e. the leading vehicle 402 starts braking)
ρ is the reaction time of the subject vehicle 401 (i.e. the time between the time the leading vehicle 402 starts braking and the subject vehicle 401 starts braking)
a_{max,acc} is the maximum acceleration of the subject vehicle 401
a_{min,br} is the maximum deceleration of the subject vehicle 401
a_{max,br} is the maximum deceleration of the leading vehicle 402
v_{f} is the velocity of the leading vehicle 402 when the event occurs.

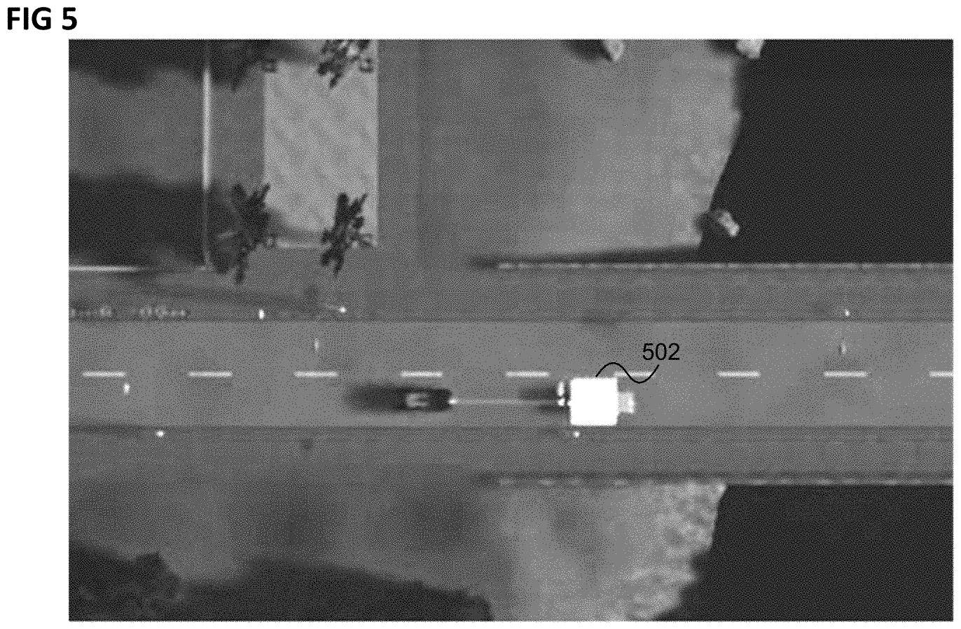

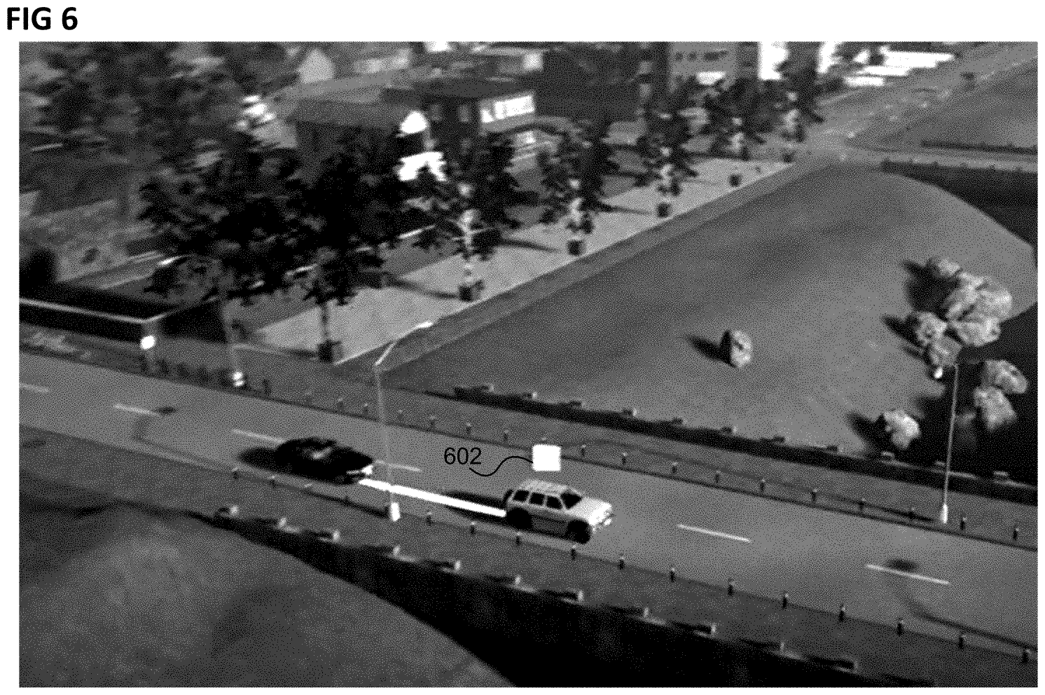

FIGS. 5 and 6 show example renderings of such an emergency break assist scenario in the simulation of 203.

Squares 501, 601 indicate the Safety Driving Model status (e.g. safe or unsafe, e.g. when the minimal distance given by equation (1) is not kept).

Meanwhile, another scenario (intersection with other vehicle's priority infraction) is relevant for both lateral, longitudinal and priority formulations of Safety Driving Model (and Safety Driving Model parameters specifying these formulations).

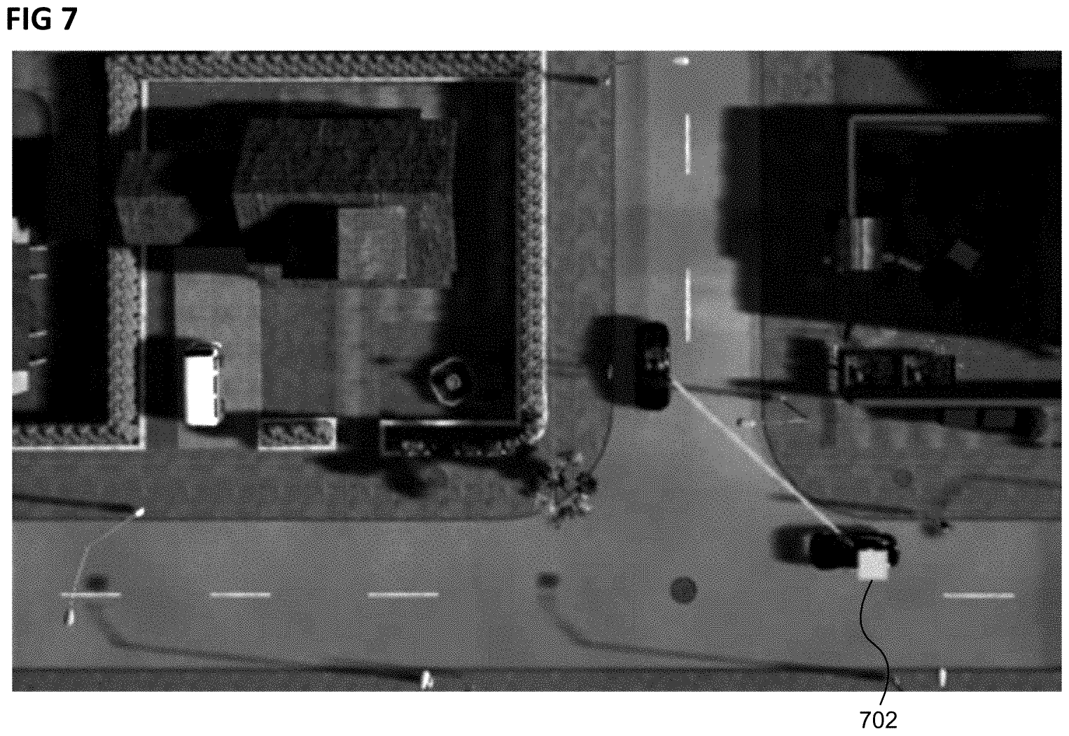

FIG. 7 shows a rendering of an intersection scenario with subject vehicle 701 performing a left turn and leading vehicle (a scripted vehicle in the simulation) ignoring red light. The Safety Driving Model Status (indicated by square 701) indicates a correctly identified dangerous situation

Using the method described above with reference to FIG. 2 the hard boundaries (fail/success) of AV safety can be automatically determined, given a choice of AV safety model parameters as well as a continuous metric of robustness. This criterion is determined per scenario or sets of scenarios that cover complete or representative cases of normal driving scenarios. The output of the method of FIG. 2 can then be used to guide the selection of configuration parameter values for AV safety, e.g. the exact parametric values that an Safety Driving Model uses in its internal formulation (e.g. for setting the behavior of an AV control scheme), e.g. to determine a minimum distance (for example as given by equation (1) below).

One approach could be to choose a conservative static configuration that guarantees safety for the explored range of scenarios. However an overly safe choice might lead to unnatural behaviors such as autonomous vehicles that maintain large following distances or that do not merge into natural traffic. Given that autonomous vehicles are forecasted to coexist with automated vehicles, a dynamic allocation of parametric values could determine the trade-off between conservative and assertive driving within the safety envelope to match human/cultural expectations. Automated vehicle makers and regulatory bodies can use the output of the method of FIG. 2 to establish dynamic ranges of operation. In such case robustness could be understood as a continuous metric of “risk” and by dynamically changing certain configuration parameters the vehicle safety solution can become more risk-tolerant or more risk-adverse.

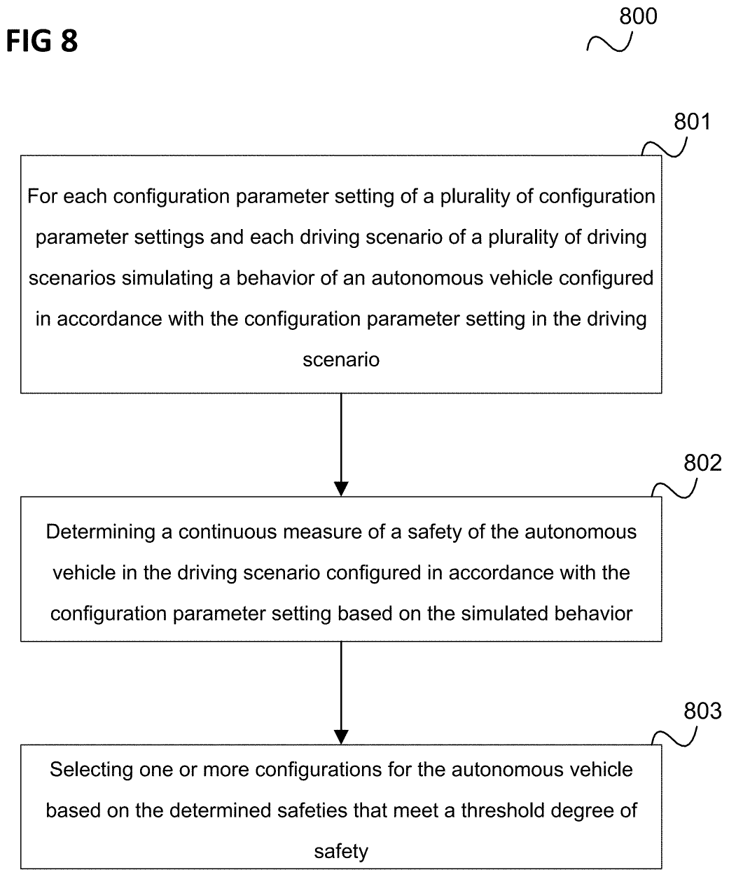

In summary, according to various embodiments a method is provided as illustrated in FIG. 8.

FIG. 8 shows a flow diagram 800 illustrating a method for determining a configuration for an autonomous vehicle, for example carried out by a data processing system (e.g. a configuration determiner).

In 801, the data processing system simulates, for each configuration parameter setting of a plurality of configuration parameter settings and each driving scenario of a plurality of driving scenarios a behavior of an autonomous vehicle configured in accordance with the configuration parameter setting in the driving scenario.

In 802, the data processing system determines a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting.

In 803, the data processing system selects one or more configurations for the autonomous vehicle based on the determined measures of a safety that meet a threshold degree of safety.

According to various embodiments, in other words, configuration parameter values combinations are tested (by simulation) in various traffic scenarios. For each configuration parameter value combinations and scenario a safety measure is determined which may indicate whether a certain level of safety is achieved (i.e. safety criterion fulfilled, such as “no accident”) and possibly a level of robustness at which the level of safety is achieved (if it is achieved), e.g. as described above for the robustness value ρ_{σ}(x̅) which may for example be the safety measure (also referred to as measure of a safety of the vehicle).

The continuous measure of a safety (and the continuous degree of safety represented by it) can be seen as a measure of how close or far the vehicle is from a defined not tolerable event (e.g. a crash) for a certain configuration parameter setting to quantify vehicle safety for that configuration parameter setting. So by using robustness as a metric a correlation to risk may be created and a description of conservative driving behaviors or assertive driving behaviors can be made based on parameter boundaries.

This continuous measure (or metric) can be used to derive traffic regulations by setting the maximum accepted risk (robustness) and then deriving individual vehicle performance parameter values such as maximum drivable speed or reaction times so this may also be used for traffic optimization and regulation.

Finally, the same technique can be applied to corner case scenario generation by modifying external parameters in the simulation. In this case the constrains for things like road geometry, street-light timing, etc. can be found. So this technique can be expanded to infrastructure planning use cases.

Based on the determined safety boundaries, a configuration for the autonomous vehicle may be determined. This may include hardware and/or software configuration parameters, such as the configuration of certain mechanical parts (e.g. type of brakes) as well as configuration parameter values according to which the autonomous vehicle is controlled by its vehicle controller (such as the maximum acceleration the autonomous vehicle uses).

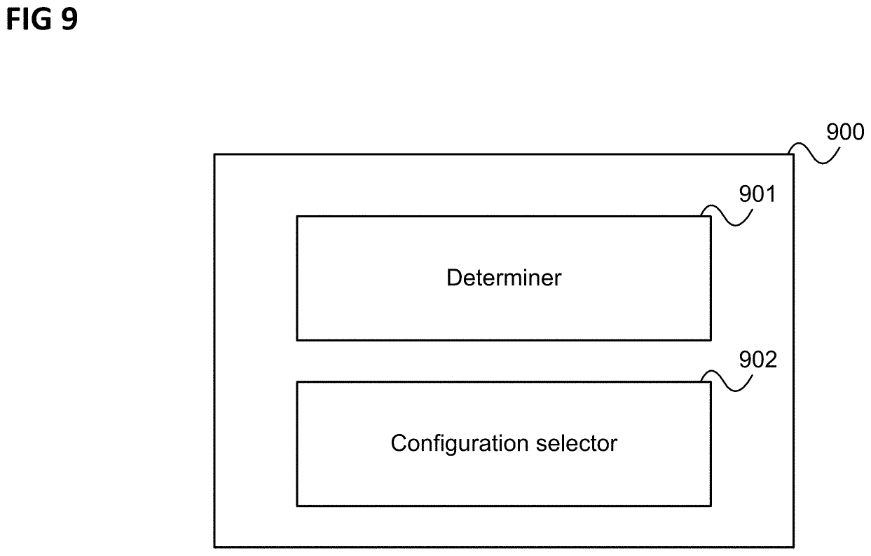

The method of FIG. 8 may be carried out by a vehicle configuration arrangement as illustrated in FIG. 9.

FIG. 9 shows a vehicle configuration arrangement 900 for determining a configuration for an autonomous vehicle.

The vehicle configuration arrangement 900 includes a determiner 901 configured to, for each configuration parameter setting of a plurality of configuration parameter settings and each driving scenario of a plurality of driving scenarios, simulate a behavior of an autonomous vehicle configured in accordance with the configuration parameter setting in the driving scenario and determine a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting.

The vehicle configuration arrangement 900 further includes a configuration selector 902 configured to select one or more configurations for the autonomous vehicle based on the determined measures of a safety that meet a threshold degree of safety.

The vehicle configuration arrangement (e.g. corresponding to configuration determiner 108) may for example be implemented by one or more processors. A “processor” may be understood as any kind of a logic implementing entity, which may be special purpose circuitry or a processor executing software stored in a memory, firmware, or any combination thereof. Thus a “processor” may be a hard-wired logic processor or a programmable logic processor such as a programmable processor, e.g. a microprocessor. A “processor” may also be a processor executing software, e.g. any kind of computer program. Any other kind of implementation of the respective functions which will be described in more detail below may also be understood as a “processor”.

The following examples pertain to further exemplary implementations.

Example 1 is a method for determining a configuration for an autonomous vehicle as illustrated in FIG. 8.

In Example 2, the subject-matter of Example 1 may optionally include each configuration parameter setting includes a configuration parameter value for each configuration parameter of a plurality of configuration parameters.

In Example 3, the subject-matter of any one of Examples 1-2 may optionally include the plurality of configuration parameter settings including, for each driving scenario of the plurality of driving scenarios, a sequence of configuration parameter settings, and a configuration parameter setting differing from a subsequent configuration parameter setting of the sequence of configuration parameter settings in the value at least one configuration parameter of the plurality of configuration parameters.

In Example 4, the subject-matter of any one of Examples 1-3 may optionally include determining, for each driving scenario of the plurality of driving scenarios and each configuration parameter setting, a subsequent configuration parameter setting of the sequence of configuration parameter settings.

In Example 5, the subject-matter of Example 4 may optionally include determining the subsequent configuration parameter setting for a configuration parameter setting based on the measure of a safety determined for the configuration parameter setting.

In Example 6, the subject-matter of any one of Examples 4-5 may optionally include determining the subsequent configuration parameter setting for a configuration parameter setting based on the measure of a safety determined for one or more configuration parameter settings preceding the configuration parameter setting.

In Example 7, the subject-matter of any one of Examples 4-6 may optionally include determining the subsequent configuration parameter setting for a configuration parameter setting based on a search, over the plurality of configuration parameter settings, for configuration parameter settings with a minimum measure of a safety, a maximum measure of a safety or at the boundary between safe and unsafe configuration parameter settings.

In Example 8, the subject-matter of any one of Examples 1-7 may optionally include determining, for each driving scenario, one or more configurations parameter settings with a minimum measure of a safety, a maximum measure of a safety or at the boundary between safe and unsafe configuration parameter settings and selecting the one or more configurations for the autonomous vehicle based on the one or more configuration parameter settings found in the search.

In Example 9, the subject-matter of any one of Examples 1 to 8 may optionally include the plurality of configuration parameters including one or more autonomous vehicle control parameters and configuring the autonomous vehicle in accordance with the configuration parameter setting including configuring a vehicle controller of the autonomous vehicle in accordance with values of the autonomous vehicle control parameters given by the configuration parameter setting.

In Example 10, the subject-matter of any one of Examples 1 to 9 may optionally include the measure of a safety representing whether the autonomous vehicle, configured in accordance with the configuration parameter setting, achieves a predetermined safety level in the driving scenario and representing, if the autonomous vehicle achieves the predetermined safety level, a level of robustness at which it achieves the predetermined safety level.

In Example 11, the subject-matter of any one of Examples 1-10 may optionally include configuring the autonomous vehicle in accordance with the selected one or more configurations.

In Example 12, the subject-matter of any one of Examples 1-11 may optionally include setting the threshold degree of safety based on traffic regulations.

In Example 13, the subject-matter of any one of Examples 1-12 may optionally include selecting a driving behavior for the autonomous vehicle and setting the threshold degree of safety based on the driving behavior.

Example 14 is a vehicle configuration arrangement for determining a configuration for an autonomous vehicle as illustrated in FIG. 9.

In Example 15, the subject-matter of Example 14 may optionally include each configuration parameter setting including a configuration parameter value for each configuration parameter of a plurality of configuration parameters.

In Example 16, the subject-matter of Example 15 may optionally include the plurality of configuration parameter settings including, for each driving scenario of the plurality of driving scenarios, a sequence of configuration parameter settings, and a configuration parameter setting differing from a subsequent configuration parameter setting of the sequence of configuration parameter settings in the value at least one configuration parameter of the plurality of configuration parameters.

In Example 17, the subject-matter of Example 16 may optionally include the determiner being further configured to determine, for each driving scenario of the plurality of driving scenarios and each configuration parameter setting, a subsequent configuration parameter setting of the sequence of configuration parameter settings.

In Example 18, the subject-matter of Example 17 may optionally include the determiner being configured to determine the subsequent configuration parameter setting for a configuration parameter setting based on the measure of a safety determined for the configuration parameter setting.

In Example 19, the subject-matter of Examples 17 or 18 may optionally include the determiner being configured to determine the subsequent configuration parameter setting for a configuration parameter setting based on the measure of a safety determined for one or more configuration parameter settings preceding the configuration parameter setting.

In Example 20, the subject-matter of any one of Examples 17-19 may optionally include the determiner being configured to determine the subsequent configuration parameter setting for a configuration parameter setting based on a search, over the plurality of configuration parameter settings, for configuration parameter settings with a minimum measure of a safety, a maximum measure of a safety or at the boundary between safe and unsafe configuration parameter settings.

In Example 21, the subject-matter of any one of Examples 14-20 may optionally include the determiner being configured to determine, for each driving scenario, one or more configurations parameter settings with a minimum measure of a safety, a maximum measure of a safety or at the boundary between safe and unsafe configuration parameter settings and the configuration selector being configured to select the one or more configurations for the autonomous vehicle based on the one or more configuration parameter settings found in the search.

In Example 22, the subject-matter of any one of Examples 14-21 may optionally include the plurality of configuration parameters including one or more autonomous vehicle control parameters and configuring the autonomous vehicle in accordance with the configuration parameter setting including configuring a vehicle controller of the autonomous vehicle in accordance with values of the autonomous vehicle control parameters given by the configuration parameter setting.

In Example 23, the subject-matter of any one of Examples 14-22 may optionally include the measure of a safety representing whether the autonomous vehicle, configured in accordance with the configuration parameter setting, achieves a predetermined safety level in the driving scenario and representing, if the autonomous vehicle achieves the predetermined safety level, a level of robustness at which it achieves the predetermined safety level.

In Example 24, the subject-matter of any one of Examples 14-23 may optionally include a vehicle configurator configured to configure the autonomous vehicle in accordance with the selected one or more configurations.

In Example 25, the subject-matter of any one of Examples 14-24 may optionally include a controller configured to set the threshold degree of safety based on traffic regulations.

In Example 26, the subject-matter of any one of Examples 14-25 may optionally include a controller configured to select a driving behavior for the autonomous vehicle and to set the threshold degree of safety based on the driving behavior.

In Example 27, the subject-matter of any one of Examples 14 to 26 may optionally include a vehicle controller configured to control a vehicle according to the selected one or more configurations.

Example 28 is a computer program element including instructions which, when executed by one or more processors, make the one or more processors perform a method for determining a configuration for an autonomous vehicle according to any one of Examples 1 to In Example 13.

Example 29 is a non-volatile computer-readable medium having instructions recorded thereon which, when executed by one or more processors, make the one or more processors perform a method for determining a configuration for an autonomous vehicle according to any one of Examples 1 to 13.

Example 30 is a vehicle configuration arrangement including determining means for, for each configuration parameter setting of a plurality of configuration parameter settings and each driving scenario of a plurality of driving scenarios simulating a behavior of an autonomous vehicle configured in accordance with the configuration parameter setting in the driving scenario and determining a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting and selecting means for selecting one or more configurations for the autonomous vehicle based on the determined measures of a safety that meet a threshold degree of safety.

It should be noted that one or more of the features of any of the examples above may be combined with any one of the other examples.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A method for determining a configuration for an autonomous vehicle comprising:
for each configuration parameter setting of a plurality of configuration parameter settings and each driving scenario of a plurality of driving scenarios
simulating a behavior of an autonomous vehicle configured in accordance with the configuration parameter setting in the driving scenario; and
determining a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting; and
selecting one or more configurations for the autonomous vehicle based on the determined measures of a safety that meet a threshold degree of safety.

2. The method of claim 1, wherein each configuration parameter setting comprises a configuration parameter value for each configuration parameter of a plurality of configuration parameters.

3. The method of claim 2, wherein the plurality of configuration parameter settings comprises, for each driving scenario of the plurality of driving scenarios, a sequence of configuration parameter settings, and wherein a configuration parameter setting differs from a subsequent configuration parameter setting of the sequence of configuration parameter settings in the value at least one configuration parameter of the plurality of configuration parameters.

4. The method of claim 3, further comprising determining, for each driving scenario of the plurality of driving scenarios and each configuration parameter setting, a subsequent configuration parameter setting of the sequence of configuration parameter settings.

5. The method of claim 4, comprising determining the subsequent configuration parameter setting for a configuration parameter setting based on the measure of a safety determined for the configuration parameter setting.

6. The method of claim 4, comprising determining the subsequent configuration parameter setting for a configuration parameter setting based on the measure of a safety determined for one or more configuration parameter settings preceding the configuration parameter setting.

7. The method of claim 4, comprising determining the subsequent configuration parameter setting for a configuration parameter setting based on a search, over the plurality of configuration parameter settings, for configuration parameter settings with a minimum measure of a safety, a maximum measure of a safety or at the boundary between safe and unsafe configuration parameter settings.

8. The method of claim 1, determining, for each driving scenario, one or more configurations parameter settings with a minimum measure of a safety, a maximum measure of a safety or at the boundary between safe and unsafe configuration parameter settings and selecting the one or more configurations for the autonomous vehicle based on the one or more configuration parameter settings found in the search.

9. The method of claim 1, wherein the plurality of configuration parameters include one or more autonomous vehicle control parameters and configuring the autonomous vehicle in accordance with the configuration parameter setting comprises configuring a vehicle controller of the autonomous vehicle in accordance with values of the autonomous vehicle control parameters given by the configuration parameter setting.

10. The method of claim 1, wherein the measure of a safety represents whether the autonomous vehicle, configured in accordance with the configuration parameter setting, achieves a predetermined safety level in the driving scenario and represents, if the autonomous vehicle achieves the predetermined safety level, a level of robustness at which it achieves the predetermined safety level.

11. The method of claim 1, further comprising configuring the autonomous vehicle in accordance with the selected one or more configurations.

12. The method of claim 1, further comprising setting the threshold degree of safety based on traffic regulations.

13. The method of claim 1, further comprising selecting a driving behavior for the autonomous vehicle and setting the threshold degree of safety based on the driving behavior.

14. A vehicle configuration arrangement for determining a configuration for an autonomous vehicle comprising:
a determiner configured to, for each configuration parameter setting of a plurality of configuration parameter settings and each driving scenario of a plurality of driving scenarios
simulate a behavior of an autonomous vehicle configured in accordance with the configuration parameter setting in the driving scenario; and
determine a continuous measure of a safety of the autonomous vehicle in the driving scenario configured in accordance with the configuration parameter setting based on the simulated behavior, wherein the measure represents a continuous degree of safety of the vehicle configured in accordance with the configuration parameter setting; and
a configuration selector configured to select one or more configurations for the autonomous vehicle based on the determined measures of a safety that meet a threshold degree of safety.

15. The vehicle configuration arrangement of claim 14, comprising a vehicle controller configured to control a vehicle according to the selected one or more configurations.

16. A computer program element comprising instructions which, when executed by one or more processors, make the one or more processors perform a method for determining a configuration for an autonomous vehicle according to any one of claims 1 to 13.

17. A non-volatile computer-readable medium having instructions recorded thereon which, when executed by one or more processors, make the one or more processors perform a method for determining a configuration for an autonomous vehicle according to any one of claims 1 to 13.
